(19) United States
(12) Patent Application Publication
(10) Pub. No.: US 2004/0135888 A1
(43) Pub. Date: Jul. 15, 2004

(54) Camera systems, systems of offering photographs for sale, and methods of offering photographs for sale

(76) Inventors: Kenneth Lee Oakeson, Boise, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/340,508

(22) Filed: Jan. 10, 2003

(51) Int. Cl. H04N 5/225

(52) U.S. Cl. 348/207.1

(57) ABSTRACT

Camera systems, systems of offering photographs for sale, and methods of offering photographs for sale are described. According to one aspect, a method of offering photographs for sale includes providing digital image data of an image using a camera system, wherein the image data is capable of being utilized to produce a photograph of the image, providing purchase information relative to a sale of the photograph, associating the purchase information with the image data using the camera system, addressing the image data and the purchase information using the camera system, and communicating the image data and the purchase information from the camera system to a destination where the photograph is offered for sale.

### FIELD OF THE INVENTION

Aspects of the invention relate to camera systems, systems of offering photographs for sale, and methods of offering photographs for sale.

### BACKGROUND OF THE INVENTION

Digital cameras have become increasingly popular in recent years with the immergence of camera configurations having improved sensing arrays, increased memory capacity, microprocessors of increased processing speeds, and other improvements in optics and associated electronics.

Communications networks have also experienced remarkable advancements in recent years. Private networks, public networks (e.g., the public Internet) and other network configurations are commonplace to communicate electronic data between a plurality of electronic devices, such as remotely located devices. Networks are utilized in numerous facets of everyday life to communicate textual data, email, audio data, visual data (streaming video, photographs,) etc.

Digital cameras and networks have been utilized to communicate photographs for various reasons. For example, people have utilized networks to upload electronic files of photographs from personal computers for communication to family members, offer photographs for sale, or for other reasons. Websites (e.g., lycos.com) have been developed to offer photographs for sale or otherwise disseminate photographs to the public. As the capabilities of digital cameras and the bandwidth capacity of networks continue to improve, the desire for communication of electronic files of photographs will continue to increase.

Accordingly, some arrangements enable a photographer to download files of digital photographs to a personal computer. Thereafter, the files may be transferred to a website from the personal computer. These arrangements have associated drawbacks including requiring a plurality of user operations to communicate the files to a destination which may delay or impede the ability of the user to make the photographs available for sale or dissemination.

As described below, exemplary aspects of the invention provide improved methods and apparatus for communicating image data of photographs and offering photographs for sale.

### DESCRIPTION OF THE DRAWINGS

FIG. 1 is an illustrative representation of an exemplary photograph dissemination system according to one embodiment.

FIG. 2 is an illustrative representation of an exemplary camera system according to one embodiment.

FIG. 3 is a functional block diagram of another exemplary camera system according to one embodiment.

FIG. 4 is a flow chart depicting an exemplary methodology executable within a camera system according to one embodiment.

FIG. 5 is a flow chart illustrating an exemplary methodology for disseminating photographs according to one embodiment.

### DETAILED DESCRIPTION OF THE INVENTION

According to one aspect, a camera system comprises an imaging system configured to provide digital image data of an image, wherein the image data is capable of being utilized to produce a photograph of the image, processing circuitry coupled with the imaging system and configured to associate purchase information relative to a sale of the photograph with the image data and to address the image data and the associated purchase information for communication to a destination where the photograph is offered for sale, and an interface configured to output the image data and the associated purchase information addressed to the destination.

According to another aspect of the invention, a camera system comprises means for providing digital image data of an image, wherein the image data is capable of being utilized to produce a photograph of the image, means for providing purchase information relative to a sale of the photograph, means for associating the purchase information with image data, and means for communicating the image data and the purchase information to a destination.

According to an additional aspect of the invention, a system of offering photographs for sale comprises a camera system configured to generate digital image data capable of being utilized to produce a photograph of the images, to associate purchase information relative to a sale of the photographs with respective ones of the digital image data and to output the digital image data and the respective purchase information; and an image broker device configured to communicate with the camera system, to receive the image data and the purchase information from the camera system, to communicate information regarding the availability of the image data for purchase, to communicate the purchase information, and to communicate the image data to selected ones of the purchasers.

According to yet another aspect of the invention, a method of offering photographs for sale comprises providing digital image data of an image using a camera system, wherein the image data is capable of being utilized to produce a photograph of the image, providing purchase information relative to a sale of the photograph, associating the purchase information with the image data using the camera system, addressing the image data and the purchase information using the camera system, and communicating the image data and the purchase information from the camera system to a destination where the photograph is offered for sale.

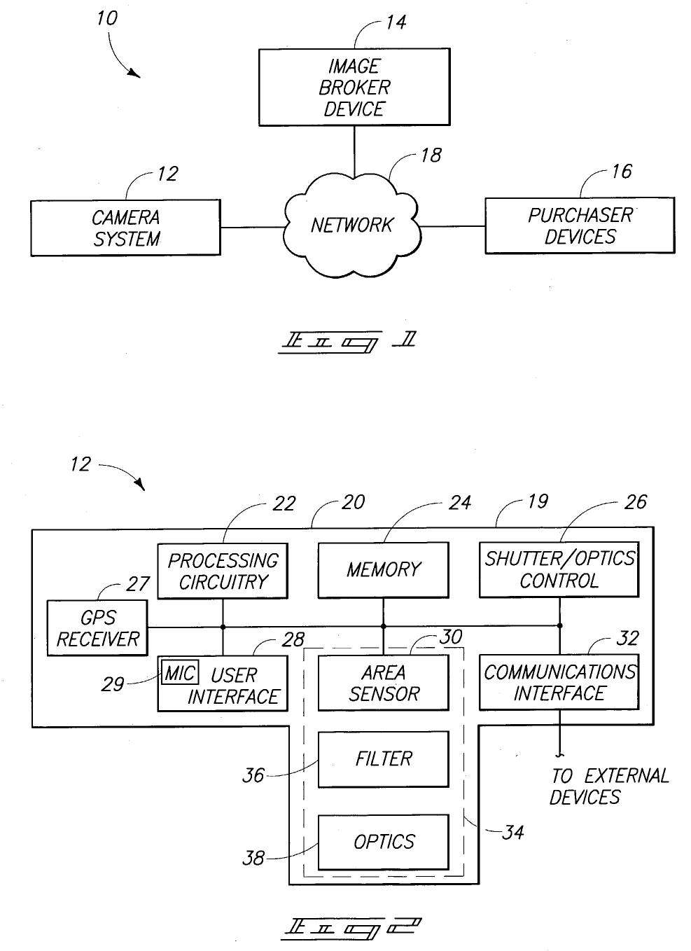

FIG. 1 depicts an exemplary photograph dissemination system 10 according to one aspect of the invention. The illustrated system 10 includes a camera system 12, and an image broker device 14 coupled with a network 18. A plurality of purchaser devices 16 are also illustrated coupled with network 18.

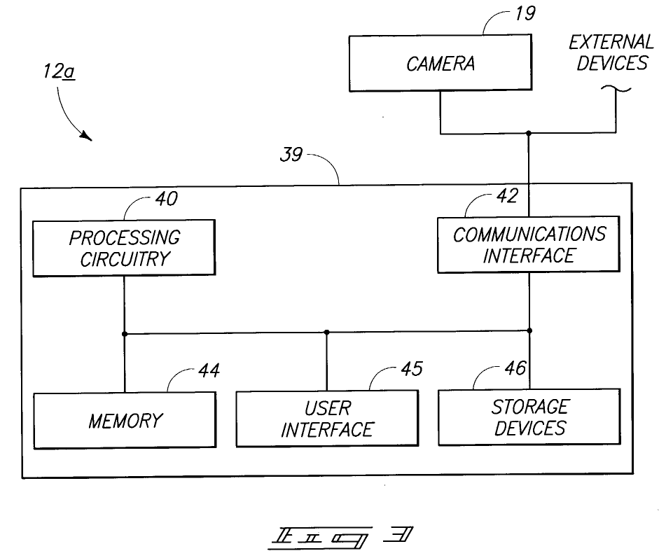

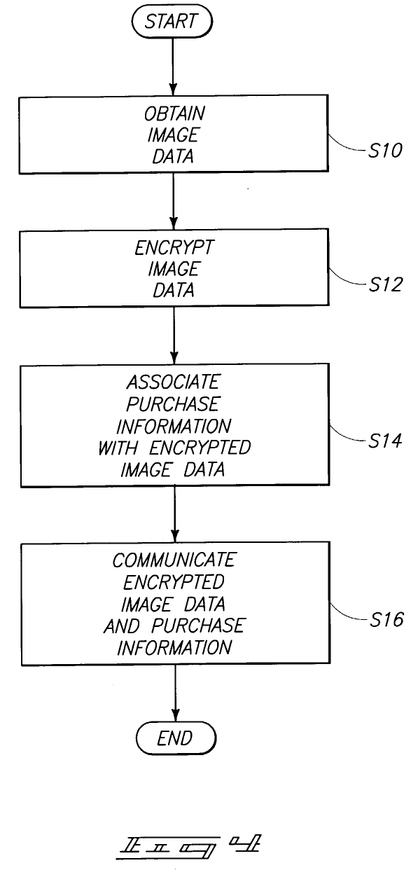

A plurality of exemplary camera systems 12 are described herein with respect to FIGS. 2 and 3. Camera systems 12 are configured to provide digital image data and associated purchase information. The digital image data is capable of being utilized to produce photographs of images and may be embodied in various digital formats, such as TIFF, JPEG, or any other format capable of being utilized to produce photographs of images.

As described herein, exemplary associated purchase information includes information pertinent to a sale of the respective photographs, using for example, image broker device 14 and network 18. For example, purchasing information may include pricing information indicating a cost to purchase the associated digital image data, authorship information regarding the photographer who created the photograph and associated digital image data, copyright data, environment information regarding the subject matter of the image (e.g., circumstances and the location or place where the image data was generated), temporal information (e.g., date and time the image data was created) and any other information beneficial to a prospective purchaser considering purchasing the image data. Accordingly, camera system 12 is configured according to exemplary aspects to generate digital image data capable of being utilized to produce photographs of images, to associate purchase information relative to a sale of the image data and to communicate the digital image data and respective purchase information externally for sale.

In the illustrated exemplary embodiment, camera system 12 is arranged to communicate the digital image data and associated purchase information using network 18. In one embodiment, camera system 12 is arranged to address the digital image data and associated purchase information to image broker device 14. For example, camera system 12 may be programmed with an appropriate identifier (e.g., network address such as an IP address) of image broker device 14 and configured to communicate the digital image data and purchase information to image broker device 14 using network 18 and the appropriate network address.

Network 18 is arranged to facilitate communication of electronic data between a plurality of nodes and devices coupled with the nodes. Network 18 may be arranged, for example, as a packet-switched communications network and may implement communications of electronic data in accordance with the Internet Protocol. Network 18 may comprise components of a private network and/or a public network (e.g., the public Internet) and include routers, servers and other appropriate components to facilitate communication of the digital image data and purchase information. Other configurations of network 18 are possible to communicate the digital image data and purchase information.

Image broker device 14 is arranged to communicate with network 18, camera system 12, and purchaser devices 16. Image broker device 14 may be configured as a web server configured to receive a plurality of requests from network 18 and to serve up or communicate data using network 18 responsive to received requests.

In the described exemplary configuration of FIG. 1, image broker device 14 is arranged to receive image data and associated purchase information from camera system 12. Image broker device 14 may index the image data and respective purchase information for subsequent retrieval or providing information to purchasing devices 16. Image broker device 14 is configured to receive inquiries or requests from remote devices, such as purchaser devices 16. For example, in one operational aspect, image broker device 14 makes available information regarding various photographs for sale. The available information may include encrypted image data of the photographs, thumbnails of the photographs, the actual image data, textual data describing the photographs, etc. The information enables prospective purchasers to gain information of available photographs for purchase. The information may be communicated by device 14 responsive to inquiries, or posted for downloading by prospective purchasers in some arrangements. In addition, image broker device 14 may communicate the respective purchase information associated with the image data indicating the availability of the image data and the conditions or terms for purchase.

As mentioned above, encrypted image data, thumbnails of the image data, the image data or other data may be made available by device 14. Camera system 12 may encrypt the image data (e.g., a color channel, every other pixel, blocks of the image, entire image, etc.), provide thumbnail data or provide the data in other formats to device 14 enabling image broker device 14 to post information regarding the image data without making the image data available without purchase.

Thereafter, image broker device 14 may receive purchase indications from purchaser devices 16 indicating a desirability to purchase the image data. Purchase indications may be provided in any suitable form, and include, for example, payment information (e.g., credit card information), account identification information to be debited, or any other form of an appropriate purchase indication. Image broker device 14 may perform verification operations including charging the provided credit card, checking the provided account number versus an internal database, etc.

Image broker device 14 may communicate the image data to an appropriate purchaser device 16 responsive to the reception of a purchase indication and appropriate verification. In one aspect, image broker device 14 may be configured to decrypt the encrypted image data and to communicate the decrypted image data to the appropriate purchaser device 16. In one arrangement, camera system 12 utilizes a public key provided by or obtained from the image broker device 14 or other source to encrypt the image data. Upon receipt of a purchase indication and verification of a purchase from an appropriate purchaser device 16, image broker device 14 may operate to decrypt the encrypted image data utilizing its own private key and to forward the decrypted image data to the respective purchaser devices 16. If a thumbnail is communicated initially, image broker device 14 may operate to communicate the appropriate image data following respective purchase and verification operations of the purchaser devices 16. Other encryption techniques (e.g., shared secret cryptography) or verification operations may be utilized to safeguard the image data. Alternatively, an honor system may be utilized wherein the full image data and associated purchase information is provided using image broker device 14 and available for downloading to purchaser devices 16.

Image broker device 14 may also provide searching functionality to enable purchaser devices 16 to search available image data. Processing circuitry of image broker device 14 may field search requests from external devices, search databases of image data using textual search techniques and/or visual object recognition technology and provide search results to purchaser devices 16. Thereafter, device 14 may monitor for the receipt of purchase indications from purchaser devices 16 responsive to communication of the search results.

Referring to FIG. 2, details of an exemplary camera system 12 are illustrated. The depicted camera system 12 is configured as a digital camera 19, such as a digital still camera, digital video camera or other appropriate digital camera device. Exemplary configurations of digital camera 19 include a Model 812 or a Model 912, both available from Hewlett-Packard Company. Camera 19 may be utilized in stand-alone applications, such as the configuration of camera system 12 shown in FIG. 2, or with other components of a system. For example, FIG. 3 depicts camera 19 in another exemplary system configuration coupled with a host device 39 and referred to as reference 12a.

As shown in FIG. 2, the exemplary camera 19 includes a housing 20, processing circuitry 22, memory 24, shutter/optics control 26, Globally Positioning System (GPS) receiver 27 or other location determining device, user interface 28, area sensor 30, communications interface 32, and an imaging system 34. The illustrated exemplary imaging system 34 includes area sensor 30, a filter 36 and optics 38 comprising digital imaging components configured to provide raw digital image data of a plurality of raw images (e.g., single full plane mosaic images of data). The raw image data comprises digital data corresponding to a plurality of pixels of the raw images formed by area sensor 30 and filter 36. For example, the raw images comprise bytes corresponding to the colors of red, green, and blue at respective pixels in an exemplary RGB application. Other embodiments may utilize cyan, magenta, yellow and black (CMYK) information, or other information.

Processing circuitry 22 is implemented as a microcontroller in an exemplary configuration. Processing circuitry 22 is configured to execute instructions to control operations of camera 19 and the generation of image data. For example, processing circuitry 22 may process data generated by area sensor 30 including, for example, performing sharpening operations of image data, smoothing operations of image data, and demosaicing of image data. Additionally, circuitry 22 may control operations of user interface 28 including controlling the display of information using user interface 28 and the processing of inputted data received via user interface 28. Processing circuitry 22 may also control association of purchase information with the image data and communication of the image data and purchase information using communications interface 32.

Memory 24 is arranged to store digital information and instructions. Memory 24 may include a buffer configured to receive raw raster data of images from area sensor 30 and to store such data for processing. Memory 24 may be embodied as random access memory (RAM), read only memory (ROM), flash memory or other configuration capable of storing digital information including image data, instructions (e.g., software or firmware instructions utilized by processing circuitry 22), or any other digital data desired to be stored.

Shutter/optics control 26 implements focusing operations of optics 38, controls a shutter (not shown) and an aperture (not shown) of optics 38, performs zoom operations, and any other desired control operations of optics 38. In one embodiment, shutter/optics control 26 includes a plurality of motors which are controlled by processing circuitry 22.

GPS receiver 27 may be utilized to automatically provide location information during generation of digital image data. Processing circuitry 22 may associate the location information with respective digital image data. Purchaser devices 16 may query or access the associated information for specific locations, times, or dates to obtain desired photographs. Other location determination apparatus and/or techniques may be utilized including utilization of a specific cellular site, triangulation using multiple cell cites, etc.

Area sensor 30 comprises a plurality of photosensitive elements corresponding to pixels and configured to provide digital data for generating photographs. For example, area sensor 30 may comprise a raster of photosensitive elements arranged in 1,600 columns by 1,280 rows in one possible configuration. Other raster configurations are possible. Exemplary photosensitive element configurations include photodiodes, charge-coupled devices (CCDs) or CMOS devices in exemplary configurations.

Filter 36 is implemented between area sensor 30 and optics 38. Filter 36 is arranged to implement filtering operations of light received from optics 38 and prior to application of the light to sensor 30. Exemplary filters 36 include Bayer Mosaic patterns. Other filter configurations and area sensor configurations are possible.

During exemplary usages, camera 19 is utilized to obtain digital image data of images using imaging system 34 and area sensor 30. Camera 19 is configured in one embodiment to provide desired processing of the image data to provide the data within proper formats for communication and subsequent generation of photographs. Processing of the image data may be performed externally of camera 19 in other arrangements.

As mentioned above, some aspects of the invention provide encryption of image data. Following generation and processing of appropriate image data, processing circuitry 22 may operate to encrypt at least a portion of the image data. In one possible embodiment, processing circuitry 22 utilizes a public key provided by or obtained from the image broker device 14 or other source to encrypt the image data. The public key corresponds to an associated private key of image broker device 14 which may be utilized to decrypt the encrypted image data.

According to additional aspects of the invention, camera 19 is configured to associate purchase information relative to a sale of the photographs with the image data. The associated purchase information may be loaded or otherwise provided within camera 19 in a plurality of exemplary methods. For example, communications interface 32 may be coupled with an external device, such as a host personal computer, and an individual may enter desired purchase information to be associated with the image data using the coupled host computer. Following downloading of the desired purchase information, the camera 19 may be disconnected from the host computer and utilized in a stand-alone application to generate the image data and perform communications operations described herein.

In another possible arrangement, user interface 28 may be utilized by a user to input desired purchase information. In one exemplary configuration, user interface 28 includes a microphone 29, keypad and/or display (the keypad and display are not shown). The microphone and/or keypad can be utilized by a user to input desired purchase information into camera 19.

If a microphone of user interface 28 is utilized to input purchase information into camera 19, the audio information may be attached as an audio file to the associated image data, or alternatively, converted to text using processing circuitry 22 (executing speech-to-text functionality) and thereafter associated with the image data. The purchase information received from a host device, via user interface or other input device may be stored within memory 24 for association with appropriate image data.

According to aspects of the invention, camera 19 is arranged to prompt a user as to whether they wish to sell the photograph and, if so, for the appropriate purchase information if not already provided. The user may respond using the exemplary procedures described above. In: accordance with other exemplary embodiments described above, previously provided purchase information is retrieved and associated with the image data.

Various exemplary methodologies are described for associating purchase information with the image data. In one exemplary configuration, processing circuitry 22 is configured to provide the purchase information as a watermark to associate the purchase information with the image data. For example, PictureMarc™ software available from DigiMarc Corporation may be utilized to embed the purchase information as imperceptible data within the image data.

In another configuration, processing circuitry 22 is arranged to provide purchase information as tagged data within the image data to associate the purchase information with the image data. For example, in a TIFF format, tags may be utilized to insert the purchase information into the image data. The tagged information will not affect resultant photographs generated using the image data.

In another exemplary configuration, processing circuitry 22 is arranged to bundle the purchase information with the image data in a common file. For example, PKZIP 5.0 software available from PKWare, Inc. may be utilized to generate zip files including the purchase information and the image data.

Following appropriate association of purchase information with the image data, camera 19 is arranged to communicate the associated data externally of camera 19. A plurality of communication methods may be utilized to communicate the purchase information and image data externally to image broker device 14 or another appropriate destination. In one example, communications interface 32 is arranged to implement wireless communications using, for example, cellular General Packet Radio Service (GPRS) technology to communicate the purchase information and associated image data. Other wireless communications protocols are possible (i.e., CDMA, 802.11).

Camera 19 may be provided with an appropriate identifier of image broker device 14. Following the generation of the image data and appropriate association of purchase information with the image data, processing circuitry 22 may control communications interface 32 to wirelessly communicate the data to network 18 and image broker device 14. In another possible configuration, communications interface 32 may be directly coupled with a node of network 18 and the image data and purchase information may be communicated via a hard-wired connection. Other communication methods may be utilized. For example, cameras may be embedded within mobile phones, which could provide the communication mechanism.

In one embodiment, processing circuitry 22 is arranged to communicate the image data and purchase information automatically after the generation of the image data, the association of the purchase information with the respective image data, and without user input. In an exemplary wireless environment, processing circuitry 22 may automatically initiate wireless communications to communicate the image data and associated purchase information to the appropriate image broker device 14 using communications interface 32 and an identifier of device 14.

Referring to FIG. 3, another exemplary configuration of a camera system is depicted with respect to reference 12a. The depicted camera system 12a includes a camera 19 and a host device 39. Host device 39 may be embodied as a personal computer in one exemplary configuration and include processing circuitry 40, a communications interface 42, a memory 44, a user interface 45 and storage devices 46.

Processing circuitry 40 may include an appropriate microprocessor, such as a Pentium™ available from Intel Corporation. Communications interface 42 is arranged to implement communications with camera 19 (e.g., using a USB or other suitable peripheral connection) and external devices, such as image broker device 14 using network 18. An exemplary communications interface 42 includes a network interface card (NIC) for communications with network 18.

Memory 44 may include random access memory (RAM), read only memory (ROM), and flash memory in exemplary embodiments. Memory 44 may store executable code usable by processing circuitry 40 to control operations of host device 39 as well as image data, purchase information, identifier of device 14 or other desired information.

Storage device 46 may comprise a mass storage device and may be configured as a hard disk drive, optical drive, floppy drive or other appropriate storage device. Storage devices 46 may be utilized to store executable code usable by processing circuitry 40 as well as image data and/or appropriate associated purchase information downloaded from camera 19. Image data downloaded from camera 19 may have associated purchase information, or alternatively, processing circuitry 40 may operate to associate appropriate purchase information with the image data after downloading.

For example, user interface 45 may be utilized to receive at least some purchase information to be associated with the image data. User interface 45 may be embodied as a keyboard, mouse, microphone or other appropriate input device.

Processing circuitry 40 may operate to control communications of image data with the associated purchase information to an appropriate destination, such as image broker device 14. Processing circuitry 40 may obtain an appropriate address or other identifier of image broker device 14 from memory 44 or storage devices 46 for communication of the image data and associated purchase information.

In exemplary configurations, systems 12, 12a implement communications of image data and associated purchase information for single photographs, or alternatively, for a plurality of photographs in a batch upload operation to image broker device 14.

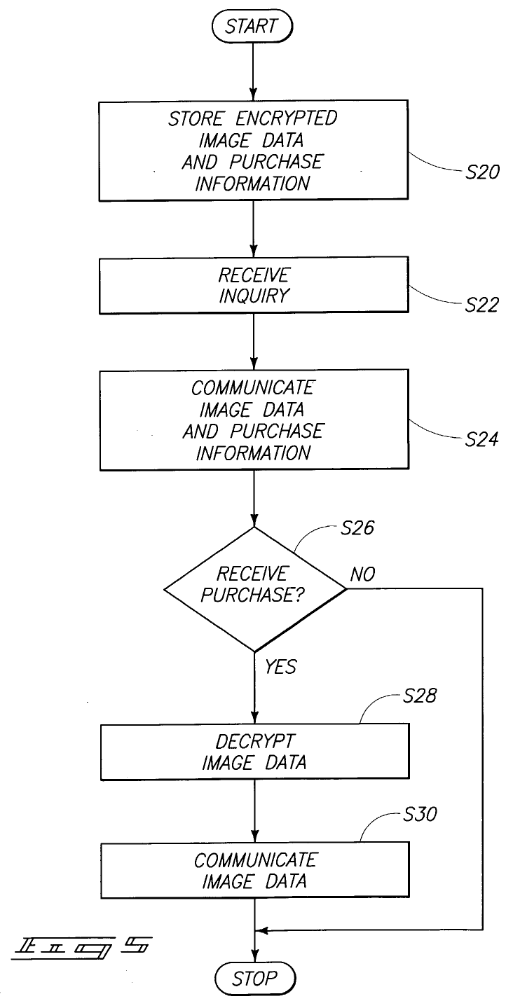

Referring to FIG. 4, an exemplary methodology executable by the camera systems 12, 12a is illustrated. The depicted methodology may be performed by processing circuitry 22, 40 of the appropriate camera systems 12, 12a. Alternative methods are possible including more, less or alternative steps.

Initially, at a step S10, the processing circuitry controls operations of the associated camera system to obtain image data. Any processing of the image data may be performed at step S10.

At a step S12, the processing circuitry operates to encrypt at least a portion of the image data.

At a step S14, the processing circuitry operates to associate purchase information with the encrypted image data.

At a step S16, the processing circuitry controls the respective communications interface to communicate the encrypted image data and associated purchase information to an appropriate destination, such as image broker device 14.

Referring to FIG. 5, an exemplary methodology executable within image broker device 14 or other recipient of the image data is shown. The depicted methodology may be executed by appropriate processing circuitry, such as a microprocessor of image broker device 14 configured as a server. Other methods are possible including more, less or alternative steps.

At a step S20, the processing circuitry operates to control storage of the encrypted image data and purchase information received from the camera system.

At a step S22, the processing circuitry receives and processes a inquiry regarding the image data.

At a step S24, the processing circuitry controls the image broker device to communicate the data regarding an image and respective purchase information to the inquiring purchaser device. The processing circuitry may decrypt image data from the camera system, create preview image data and transmit the preview image data to the respective purchaser device. The preview image data may comprise one or more of thumbnail image data, partial image data, black and white image data, encrypted or decrypted image data, copyright information and/or a watermark to indicate an unlicensed state.

At a step S26, the processing circuitry monitors for the reception of a purchase indication and appropriate verification following the communication of the encrypted image data.

If the condition of step S26 is negative, the depicted methodology may terminate.

If the condition of step S26 is affirmative, the processing circuitry proceeds to a step S28 to decrypt the image data if not previously decrypted.

At a step S30, the processing circuitry controls communication of the decrypted image data to the appropriate purchaser device.

Aspects of the invention facilitate dissemination of image data for photographs including communication of the image data to a network and/or external devices. The exemplary aspects facilitate management of photographs, sharing of photographs, and offering of photographs for sale. Some of the exemplary methods and apparatus described herein utilize networks and electronic communication capabilities of devices to communicate image data and/or associated purchase information. At least some aspects enable individuals to promptly offer photographs for sale along with associated purchase information.

The protection sought is not to be limited to the disclosed embodiments, which are given by way of example only, but instead is to be limited only by the scope of the appended claims.

What is claimed is:

1. A camera system comprising:
an imaging system configured to provide digital image data of an image, wherein the image data is capable of being utilized to produce a photograph of the image;
processing circuitry coupled with the imaging system and configured to associate purchase information relative to a sale of the photograph with the image data and to address the image data and the associated purchase information for communication to a destination where the photograph is offered for sale; and
an interface configured to output the image data and the associated purchase information addressed to the destination.

2. The system of claim 1 wherein the processing circuitry is configured to encrypt at least a portion of the image data prior to outputting the image data.

3. The system of claim 1 wherein the processing circuitry is configured to associate the purchase information comprising temporal data with the image data.

4. The system of claim 1 further comprising a microphone configured to receive audible signals and to convert the audible signals into the purchase information comprising image environment data regarding the image, and wherein the processing circuitry is configured to associate the image environment data with the image data.

5. The system of claim 1 further comprising a location determining device configured to provide the purchase information comprising location information regarding a location of the image.

6. The system of claim 1 further comprising a memory configured to store the image data.

7. The system of claim 1 wherein the imaging system, processing circuitry and the interface are embodied within a common housing of a single device comprising a camera.

8. The system of claim 1 wherein the processing circuitry is configured to communicate the image data and the purchase information automatically after the provision of the image data and the association of the purchase information and without user input.

9. The system of claim 1 wherein the interface is configured to implement wireless communications and to output the image data and the associated purchase information using wireless communications.

10. The system of claim 1 wherein the processing circuitry comprises circuitry of a camera.

11. The system of claim 1 wherein the processing circuitry comprises circuitry of a host device.

12. The system of claim 1 wherein the processing circuitry is configured to provide the purchase information as a watermark to associate the purchase information with the image data.

13. The system of claim 1 wherein the processing circuitry is configured to provide the purchase information as tagged data to associate the purchase information with the image data.

14. The system of claim 1 wherein the processing circuitry is configured to bundle the purchase information with the image data in a common file to associate the purchase information with the image data.

15. A camera system comprising:
means for providing digital image data of an image, wherein the image data is capable of being utilized to produce a photograph of the image;
means for providing purchase information relative to a sale of the photograph;
means for associating the purchase information with image data; and
means for communicating the image data and the purchase information to a destination.

16. The system of claim 15 wherein the means for providing the digital image data and the purchase information, the means for associating, and the means for communicating are embodied within a common housing of a camera.

17. The system of claim 16 wherein the means for communicating comprises means for automatically communicating the image data and the purchase information after the provision of the image data and provision of the purchase information and without user input.

18. The system of claim 16 wherein the means for communicating comprises means for communicating the image data and the purchase information using wireless communications.

19. The system of claim 15 further comprising means for encrypting at least a portion of the image data prior to communication of the image data.

20. The system of claim 15 wherein the means for communicating comprises means for communicating the purchase information and the image data using wireless communications.

21. The system of claim 15 wherein the means for providing purchase information comprises means for converting audible signals into image environment data regarding the image, and the processing circuitry is configured to associate the environment data with the image data.

22. A system of offering photographs for sale, the system comprising:
a camera system configured to provide digital image data capable of being utilized to produce a photograph of the images, to associate purchase information relative to a sale of the photographs with respective ones of the digital image data and to output the digital image data and the respective purchase information; and
an image broker device configured to communicate with the camera system, to receive the image data and the purchase information from the camera system, to communicate information regarding the availability of the image data for purchase, to communicate the purchase information, and to communicate the image data to selected ones of the purchasers.

23. The system of claim 22 wherein the camera system comprises a camera and a host device.

24. The system of claim 22 wherein the camera system comprises no more than a single device embodied as a camera.

25. The system of claim 24 wherein the camera is configured to communicate the image data and the purchase information using wireless communications.

26. The system of claim 24 wherein the camera is configured to automatically communicate the image data and the purchase information to the image broker device after the provision of the image data and provision of the purchase information and without user input.

27. The system of claim 22 wherein the image broker device is configured to receive purchase indications from the selected ones of the purchasers, and to communicate the image data to the selected ones of the purchasers responsive to the reception of the purchase indications.

28. The system of claim 22 wherein the camera system is configured to encrypt at least some of the image data, the image broker device is configured to communicate the encrypted image data and the purchase information to communicate the information regarding the availability of the image data for purchase, and the image broker device is further configured to decrypt the encrypted image data to communicate the image data to selected ones of the purchase.

29. The system of claim 22 wherein the camera system is configured to communicate thumbnail data to the image broker device, and the image broker device is configured to communicate the thumbnail data to communicate the information regarding the availability of the image data for purchase.

30. A method of offering photographs for sale comprising:
providing digital image data of an image using a camera system, wherein the image data is capable of being utilized to produce a photograph of the image;
providing purchase information relative to a sale of the photograph;
associating the purchase information with the image data using the camera system;
addressing the image data and the purchase information using the camera system; and
communicating the image data and the purchase information from the camera system to a destination where the photograph is offered for sale.

31. The method of claim 30 further comprising encrypting at least a portion of the image data prior to the communicating.

32. The method of claim 30 further comprising associating purchase information comprising temporal data with the image data.

33. The method of claim 30 further comprising converting audible signals into the purchase information comprising image environment data, and wherein the associating comprises associating the environment data with the image data.

34. The method of claim 30 wherein the providings, the associating, the addressing and the communicating comprise using a camera of the camera system.

35. The method of claim 34 wherein the communicating comprises communicating using wireless communications.

36. The method of claim 34 wherein the communicating comprises communicating automatically after the associating without user input.

37. The method of claim 30 wherein the providing the purchase information, the associating, the addressing, and the communicating comprise using a host device.

38. The method of claim 30 wherein the associating comprises providing the purchase information as a watermark.

39. The method of claim 30 wherein the associating comprises providing the purchase information as tagged data.

40. The method of claim 30 wherein the associating comprises bundling the purchase information and the image data into a common file.
